(19) United States
(12) Patent Application Publication
(10) Pub. No.: US 2026/0074437 A1
(43) Pub. Date: Mar. 12, 2026

(54) ANTENNA DEVICE

(71) Applicant: Mitsubishi Electric Corporation, Tokyo (JP)

(72) Inventors: Takuya MIYASAKA, Tokyo (JP); Shingo YAMAURA, Tokyo (JP); Kengo NISHIMOTO, Tokyo (JP)

(73) Assignee: Mitsubishi Electric Corporation, Tokyo (JP)

(21) Appl. No.: 19/388,116

(22) Filed: Nov. 13, 2025

Related U.S. Application Data
(63) Continuation of application No. PCT/JP2023/024851, filed on Jul. 5, 2023.

(51) Int. Cl. H01Q 19/15; H01Q 5/307

(52) U.S. Cl. CPC H01Q 19/15; H01Q 5/307

(57) ABSTRACT

An antenna device according to the present disclosure includes: a metal housing which includes an opening part on one surface, and in which a liquid crystal display including a transparent conductive film facing the opening part is disposed; an antenna conductor that includes an end surface forming a gap being a slot line between the end surface and an edge surrounding the opening part of the metal housing, constitutes a composite right handed/left handed transmission line on at least part of the slot line, causes the composite right handed/left handed transmission line on the slot line to function as a leaky wave antenna, and allows visible light to transmit through the antenna conductor; and a power feeding point disposed in the gap.

### CROSS REFERENCE TO RELATED APPLICATION

This application is a Continuation of PCT International Application No. PCT/JP2023/024851, filed on Jul. 5, 2023, which is hereby expressly incorporated by reference into the present application.

### TECHNICAL FIELD

The present disclosure relates to an antenna device in which a liquid crystal display including a transparent conductive film on a substantially entire surface of a liquid crystal screen is disposed inside a metal housing.

### BACKGROUND ART

Development of a transparent antenna for which a transparent conductive material having high visible light transmittance is used is advancing, and Patent Literature 1 describes an antenna device in which a liquid crystal display for which an indium tin oxide film has been used as a transparent electrode is disposed inside a metal housing.

The antenna device described in Patent Literature 1 operates as a slot antenna that has a gap provided between an edge part of a transparent antenna and the metal housing, and uses the gap as a slot.

### CITATION LIST

### Patent Literature

Patent Literature 1: JP 7,221,450 B1

### SUMMARY OF INVENTION

### Technical Problem

By the way, according to an antenna device that operates as a slot antenna having a gap between an edge part of a transparent antenna and a metal housing as a slot, a frequency that increases a gain depends on the size of the metal housing, and thus there is desired, for example, an antenna device that achieves a high gain at 2.1 GHZ, 2.7 GHZ, and 3.3 GHZ, but also in other frequency bands such as, for example, a 2.4 GHz band used for WI-FI.

The present disclosure has been made in light of the above point, and an object of the present disclosure is to provide an antenna device that can adjust a frequency that increases a gain without depending on the size of a metal housing.

### Solution to Problem

An antenna device according to the present disclosure includes: a metal housing which includes an opening part on one surface, and in which a liquid crystal display including a transparent conductive film facing the opening part is disposed; an antenna conductor that includes an end surface forming a gap being a slot line between the end surface and an edge surrounding the opening part of the metal housing, constitutes a composite right handed/left handed transmission line on at least part of the slot line, causes the composite right handed/left handed transmission line on the slot line to function as a leaky wave antenna, and allows visible light to transmit through the antenna conductor; and a power feeding point disposed in the gap, and the antenna conductor includes a slit group including a plurality of slits which have end surfaces opened in contact with the slot line, and are arranged in parallel, the plurality of slits, and a plurality of inductors electrically connected between one side surface sides of the respective plurality of slits and the metal housing constitute a left handed transmission line in the composite right handed/left handed transmission line, and a right handed transmission line of the composite right handed/left handed transmission line is present in the slot line in a region of the antenna conductor in which the slit group is formed.

### Advantageous Effects of Invention

According to the present disclosure, it is possible to obtain a high gain with respect to a wide frequency band without depending on the size of a metal housing.

### BRIEF DESCRIPTION OF DRAWINGS

FIG. 1 is a perspective view of an antenna device according to Embodiment 1.

FIG. 2 is a perspective view of a metal housing of the antenna device according to Embodiment 1.

FIG. 3 is a perspective view illustrating the antenna device according to Embodiment 1 from which a protective glass has been removed.

FIG. 4 is a cross-sectional view taken along line A-A in FIG. 1.

FIG. 5 is an equivalent circuit diagram of micro zones of a composite right handed/left handed line.

FIG. 6 is an equivalent circuit diagram of the micro zone of the right handed transmission line.

FIG. 7 is an equivalent circuit diagram of the micro zone of the left handed system composite line.

FIG. 8 is a perspective view illustrating a slot line model for designing the composite right handed/left handed line in a unit cell.

FIG. 9 is a cross-sectional view taken along line B-B in FIG. 8.

FIG. 10 is a plan view illustrating a configuration of the unit cell.

FIG. 11 is a view illustrating dispersion characteristics of the unit cell (a slit length Sl is 20 mm) indicating a relationship between a frequency and a phase change amount.

FIG. 12 is a view illustrating the dispersion characteristics o f the unit cell (the slit length Sl is 16 mm) indicating the relationship between the frequency and the phase change amount.

FIG. 13 is a perspective view illustrating a slot line model for designing a composite right handed/left handed line with 10 unit cells.

FIG. 14 is a view illustrating an electrical field distribution at a time when an electromagnetic wave of 4 GHz is caused to propagate in the slot line model for designing the composite right handed/left handed line with the 10 unit cells.

FIG. 15 is a view illustrating an electrical field distribution at a time when an electromagnetic wave of 2 GHz is caused to propagate in the slot line model for designing the composite right handed/left handed line with the 10 unit cells.

FIG. 16 is a view illustrating frequency characteristics of an absolute gain in a zenith direction in the antenna device according to Embodiment 1.

FIG. 17 is a view illustrating an absolute gain radiation pattern of a Z-Y plane at 4 GHz in the antenna device according to Embodiment 1.

FIG. 18 is a perspective view illustrating an antenna device according to a comparative example from which a protective glass has been removed.

FIG. 19 is a plan view illustrating that the protective glass has been removed from the antenna device according to the comparative example.

FIG. 20 is a cross-sectional view taken along line C-C in FIG. 19.

FIG. 21 is a perspective view illustrating an antenna device according to Embodiment 2 from which a protective glass has been removed.

FIG. 22 is a perspective view illustrating an antenna device according to Embodiment 3 from which a protective glass has been removed.

FIG. 23 is a perspective view illustrating an antenna device according to Embodiment 4 from which a protective glass has been removed.

FIG. 24 is a perspective view illustrating an antenna device according to Embodiment 5 from which a protective glass has been removed.

FIG. 25 is a perspective view illustrating an antenna device according to Embodiment 6 from which a protective glass has been removed.

FIG. 26 is a principal part enlarged view illustrating the antenna device according to Embodiment 6.

### DESCRIPTION OF EMBODIMENTS

### Embodiment 1

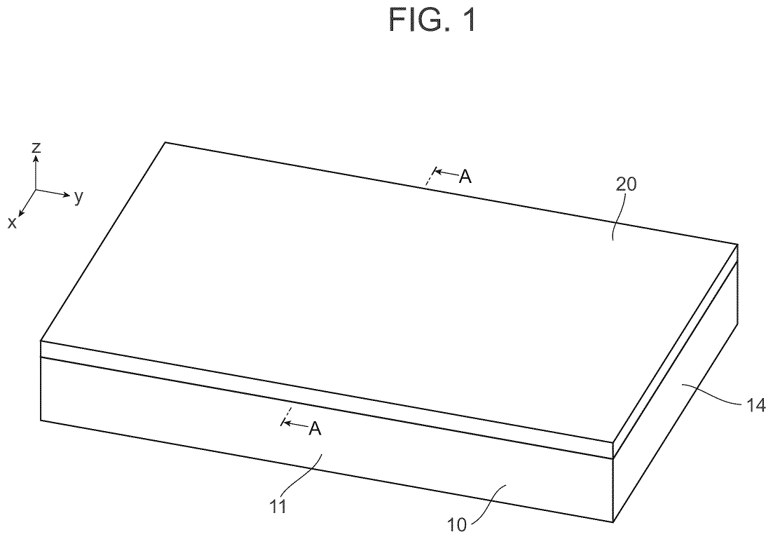

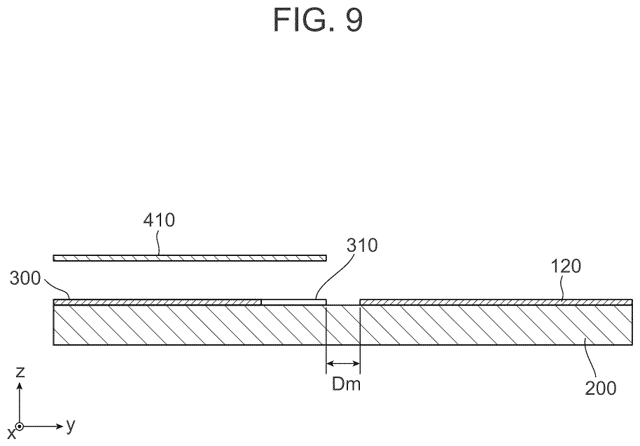

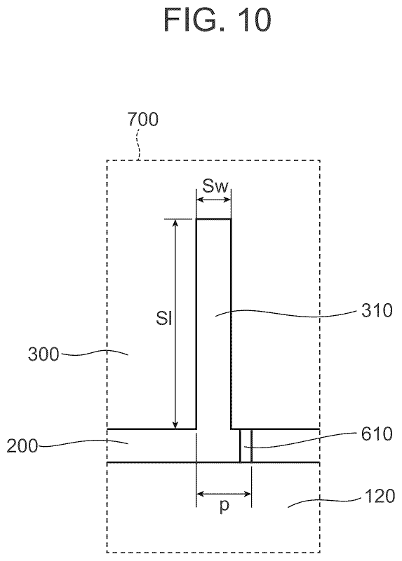

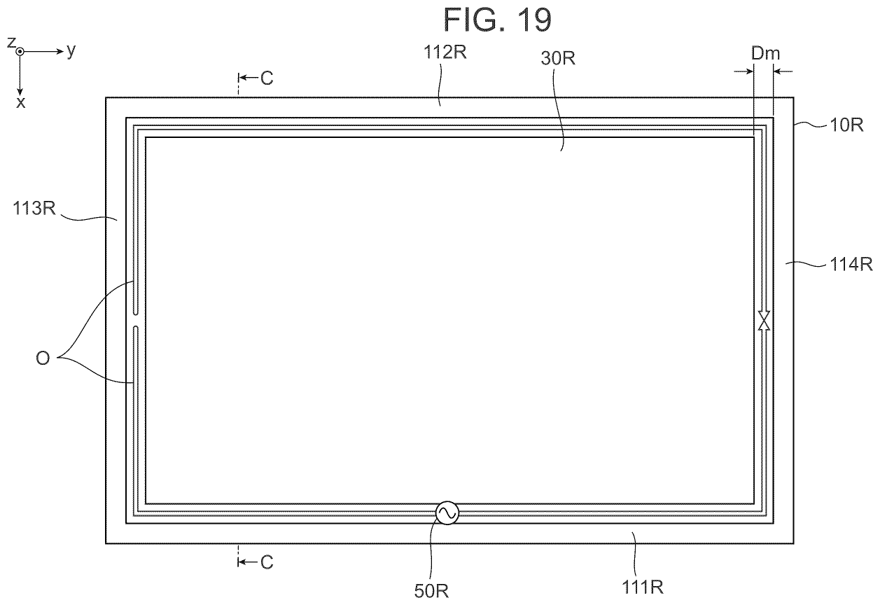

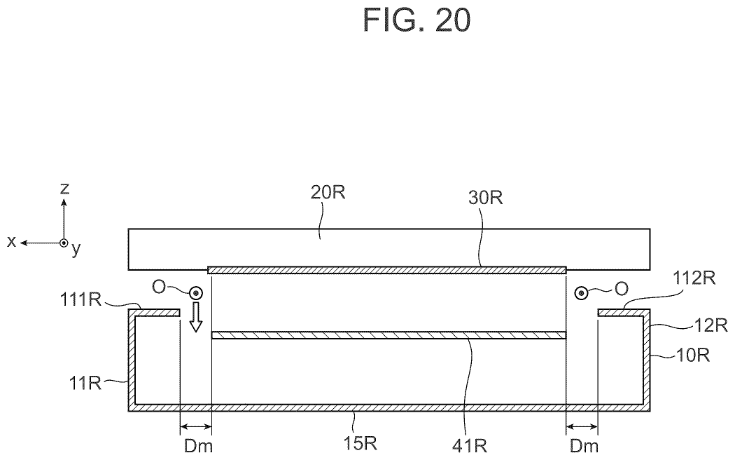

An antenna device according to Embodiment 1 will be described with reference to FIGS. 1 to 20.

The antenna device according to Embodiment 1 includes a metal housing 10, a protective glass 20, an antenna conductor 30, a power feeding point 50, and a plurality of inductors.

Note that a liquid crystal display device includes a liquid crystal display 40, and the liquid crystal display 40 is disposed inside the metal housing 10 in the antenna device.

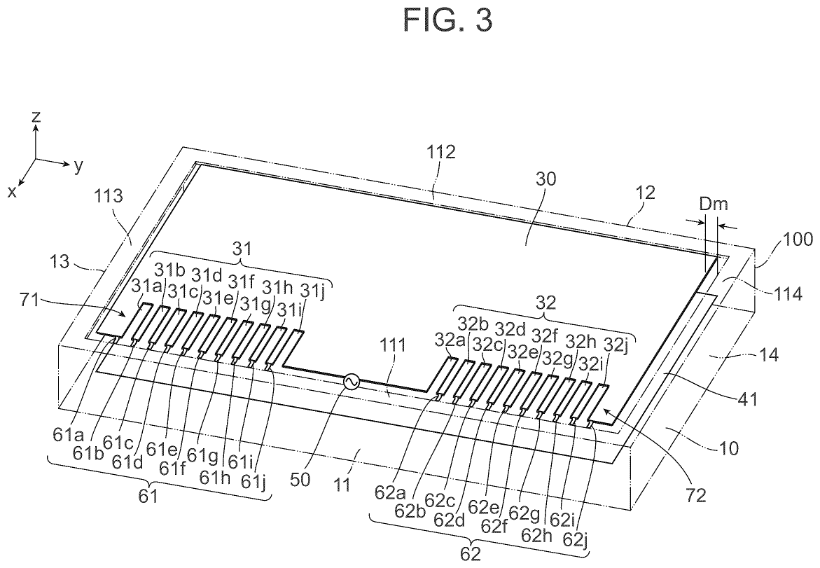

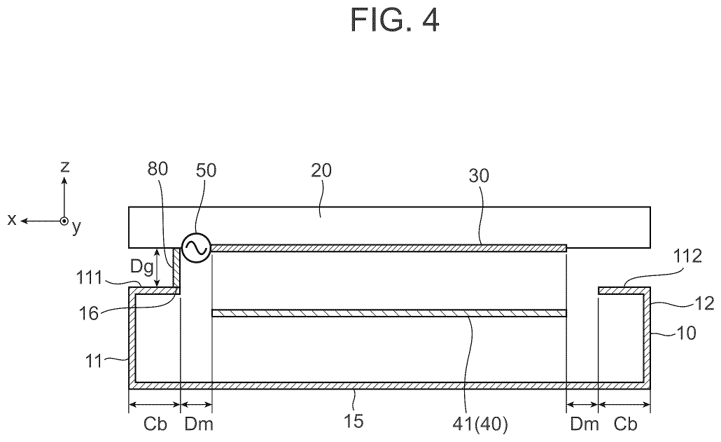

As illustrated in FIGS. 3 and 4, the liquid crystal display 40 includes a transparent electrode 41 on a substantially entire surface of a liquid crystal screen.

FIG. 3 is a perspective view illustrating that the protective glass 20 has been removed.

The transparent electrode 41 has a rectangular planar shape.

For the transparent electrode 41, a transparent conductive film that is an Indium Tin Oxide film (ITO film) is used. Hereinafter, description will be given assuming that the transparent electrode 41 is the ITO film 41.

Because a sheet resistance value of the ITO film 41 is 50 Ω/sq or more and thus very high, a loss medium is present directly below the antenna conductor 30.

That is, a current flowing on the ITO film 41 causes significant loss, and a gain lowers.

Note that, although the liquid crystal display 40 includes various components such as the liquid crystal screen and a backlight in the following description and drawings, only the ITO film 41 that is closely related to the antenna conductor 30, that is, that significantly influences radiation characteristics of an antenna is modeled, and other members that constitute the liquid crystal display 40 are omitted.

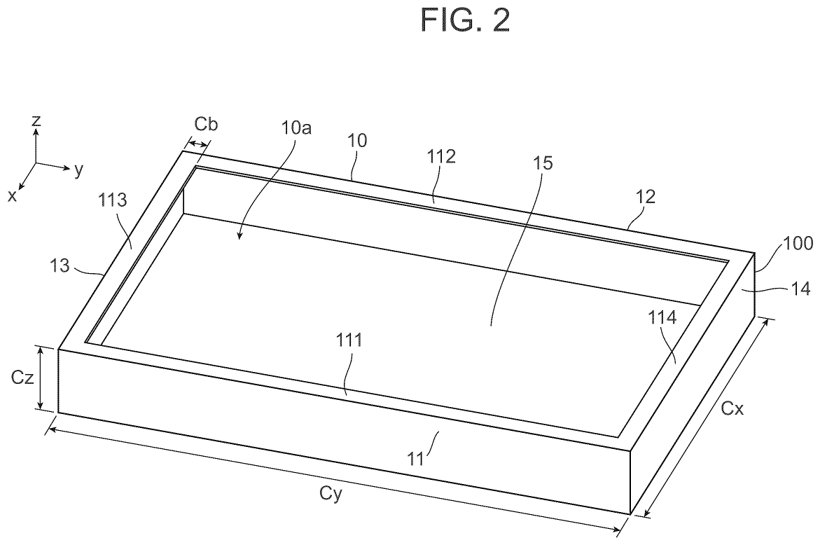

As illustrated in FIG. 2, the metal housing 10 is a cuboid that includes an opening part 10a on one surface, and includes a first sidewall 11 to a fourth sidewall 14 and a bottom plate 15. Note that, although the cuboid is used as an example, the metal housing 10 may not be the cuboid.

The first sidewall 11 and the second sidewall 12 are a pair of opposing long sidewalls, and the third sidewall 13 and the fourth sidewall 14 are a pair of opposing short sidewalls.

The opening part 10a is located at a top panel of the metal housing 10 facing the bottom plate 15, and has a rectangular shape.

In Embodiment 1, sides of the opening part 10a corresponding to the first sidewall 11 to the fourth sidewall 14 will be referred to as a first side to a fourth side.

For convenience of description, a direction along the third sidewall 13 and the fourth sidewall 14 is an x axis, a direction along the first sidewall 11 and the second sidewall 12 is a y axis, and an axis perpendicular to the plane of the bottom plate 15 is a z axis.

As illustrated in FIG. 2, the metal housing 10 has a dimension Cx in an x direction, a dimension Cy in a y direction, and a dimension Cz in a z direction.

That is, the length of an outer surface of each of the third sidewall 13 and the fourth sidewall 14 is Cx, the length of an outer surface of each of the first sidewall 11 and the second sidewall 12 is Cy, and the height of each of the first sidewall 11 to the fourth sidewall 14 is Cz.

The metal housing 10 includes: a substrate 100; and a bezel 110 that constitutes an outer frame integrally bent inwardly from the end surfaces (virtual planes) of the sidewalls of the substrate 100.

The metal housing 10 is formed with a metal, the substrate 100 is a cuboid that includes the first sidewall 11 to the fourth sidewall 14 and the bottom plate 15, and the bezel 110 constitutes a rectangular frame body integrally bent inwardly from the first sidewall 11 to the fourth sidewall 14 of the substrate 100.

Note that, although the bezel 110 is continuously extended as the metal housing 10 from the substrate 100, there may not be the bezel 110, and only the substrate 100 may constitute the metal housing 10.

Even in a case of the metal housing 10 that does not include the bezel 110 and is constituted by the substrate 100 alone, edge parts of the first sidewall 11 to the fourth sidewall 14 will be described as the bezel 110 in Embodiment 1.

The bezel 110 will be referred to as a first bezel 111 to a fourth bezel 114 corresponding to the first sidewall 11 and the fourth sidewall 14 in the following description for convenience of description.

As illustrated in FIGS. 2 and 4, the widths of edges of the first bezel 111 to the fourth bezel 114, that is, the widths of the edges surrounding the opening part 10a of the metal housing 10 are Cb.

An opening area of the opening part 10a of the metal housing 10 is {(Cx−2*Cb)*(Cy−2*Cb)}.

The protective glass 20 is disposed directly above the opening part 10a of the metal housing 10.

The protective glass 20 plays a role of protecting the liquid crystal display 40 when the liquid crystal display 40 is disposed inside the metal housing 10.

Furthermore, the antenna conductor 30 that is the transparent conductive film is mounted on the back surface of the protective glass 20, that is, the surface of the liquid crystal display 40.

As illustrated in FIG. 4, the protective glass 20 is attached to the metal housing 10 with a gap Dg provided between the back surface of the protective glass 20 and the edges of the bezel 110 of the metal housing 10.

As a result, the protective glass 20 includes the gap Dg between an end part of the antenna conductor 30 and the edges of the bezel 110 of the metal housing 10.

A user of the liquid crystal display device visually checks the liquid crystal screen of the liquid crystal display 40 through the protective glass 20 from a +Z direction to a −Z direction in a state where the protective glass 20 and the antenna conductor 30 are interposed.

The antenna conductor 30 is a transparent conductive film that allows visible light to transmit therethrough. In Embodiment 1, for example, a transparent conductive material that has a relatively low sheet resistance value of 1.5 Ω/sq is used.

The antenna conductor 30 forms a gap that is a slot line between the end surface of the antenna conductor 30 and the edges of the bezel 110 surrounding the opening part 10a of the metal housing 10.

The antenna conductor 30 is used as one base plate and the metal housing 10 is used as the other base plate to use a gap Dm (see FIGS. 3 and 4) between the antenna conductor 30 and the metal housing 10 as the slot line.

The power feeding point 50 excites electrical power for the antenna conductor 30.

When the electrical power is excited for the antenna conductor 30 by the power feeding point 50, a high-frequency current intensively flows to the edge part of the antenna conductor 30.

As illustrated in FIGS. 3 and 4, the power feeding point 50 is disposed between the antenna conductor 30 and the first bezel 111 of the metal housing 10 at a center position of the first bezel 111 of the bezel 110 of the metal housing 10, that is, at a position corresponding to the center of the first side on a side of the first side of the opening part 10a of the metal housing 10.

The power feeding point 50 is located at the same z coordinate as that of the antenna conductor 30. That is, the power feeding point 50 and the antenna conductor 30 are at the same height with respect to the edges of the bezel 110 of the metal housing 10.

The power feeding point 50 is electrically connected to the bezel 110 of the metal housing 10 by a metal sheet 80.

Hence, the antenna conductor 30 and the bezel 110 of the metal housing 10 are electrically connected via the power feeding point 50 and the metal sheet 80.

The electrical power is excited from the power feeding point 50 to the antenna conductor 30 by, for example, a Flexible Printed Circuit (FPC) cable.

As illustrated in FIG. 3, the antenna conductor 30 includes, on the side of the first side of the opening part 10a of the metal housing 10, a first slit group 31 and a second slit group 32 for each constituting a Composite Right/Left Handed transmission line (hereinafter, CRLH transmission line) in a slot line targeting at the power feeding point 50.

The first slit group 31 includes a plurality of slits 31a to 31j each of whose end surface is opened in contact with the slot line, and the plurality of slits 31a to 31j are arranged in parallel at equal intervals.

The transparent conductive film portions of the antenna conductor 30 arranged on both sides of each of the slits 31a to 31j functions as a pair of electrodes of a capacitor, and a plurality of capacitors connected in series are formed in a region of the antenna conductor 30 in which the first slit group 31 is formed.

For example, each of the slits 31a to 31j has a slit width Sw of 3 mm, and a slit length Sl of 20 mm.

A first inductor group 61 and the first slit group 31 constitute a left handed transmission line of the CRLH transmission line.

As illustrated in FIG. 3, the first inductor group 61 includes a plurality of inductors 61a to 61j electrically connected between one side surface sides of the respective plurality of slits 31a to 31j of the antenna conductor 30 and the first bezel 111 of the metal housing 10.

The plurality of inductors 61a to 61j are connected in parallel to the antenna conductor 30.

The inductance of each of the inductors 61a to 61j is 10 nH.

The plurality of slits 31a to 31j of the first slit group 31 and the plurality of inductors 61a to 61j of the first inductor group 61 are alternately aligned close to each other.

The slits 31a to 31j and the inductors 61a to 61j connected to the one side surface sides of the slits 31a to 31j are used unit cells, that is, one capacitor and one inductor are used as a unit cell, the length of the unit cell including the width of the slit and the width of the inductor in the unit cell will be referred to a period length p, and the period length p is, for example, 5 mm.

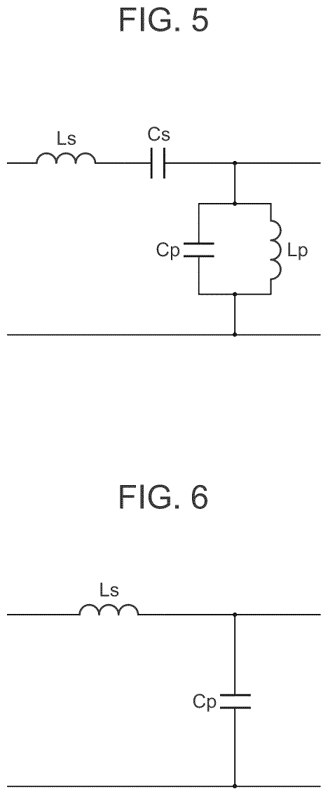

As illustrated in FIG. 5, an equivalent circuit in a micro zone of the CRLH transmission line is a circuit in which an inductor Ls is connected in series, a capacitor Cp is connected in parallel, a capacitor Cs is connected in series, and an inductor Lp is connected in parallel.

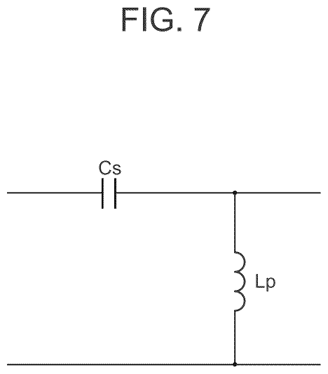

That is, the equivalent circuit in the micro zone of the CRLH transmission line is the circuit that is a mixture of an equivalent circuit in a micro zone of a right handed transmission line in which the inductor Ls is connected in series and the capacitor Cp is connected in parallel illustrated in FIG. 6, and an equivalent circuit in a micro zone of a left handed transmission line in which the capacitor Cs is connected in series and the inductor Lp is connected in parallel illustrated in FIG. 7.

In the slot line for which the antenna conductor 30 is used as the one base plate and the metal housing 10 is used as the other base plate, there is the micro zone of the right handed transmission line in which the inductor Ls is connected in series and the capacitor Cp is connected in parallel in a micro zone of the metal housing 10 and the antenna conductor 30.

Furthermore, there is the left handed transmission line formed by the plurality of capacitors that are connected in series and the plurality of inductors 61a to 61j that are connected to the antenna conductor 30 in parallel, the plurality of capacitors being present in the region of the antenna conductor 30 in which the first slit group 31 is formed.

Hence, by means of the region of the antenna conductor 30 in which the first slit group 31 including the plurality of slits 31a to 31j is formed, the first inductor group 61 that includes the plurality of inductors 61a to 61j, and the metal housing 10, there is a first CRLH transmission line 71 including: the left handed transmission line formed by the first slit group 31 and the first inductor group 61; and the right handed transmission line that is present in the slot line in the region of the antenna conductor 30 in which the first slit group 31 is formed.

The first CRLH transmission line 71 is one type of a metamaterial, and is a transmission line that indicates the property of the right handed transmission line or indicates the property of the left handed transmission line depending on a frequency.

The first CRLH transmission line 71 is present, so that it is possible to cause the first CRLH transmission line 71 on the slot line to function to operate as a leaky wave antenna.

The number of the slits 31a to 31j of the first slit group 31 and the number of the inductors 61a to 61j are 10, yet only have to be two or more instead of 10.

The second slit group 32 includes a plurality of slits 32a to 32j each of whose end surface is opened in contact with the slot line, and the plurality of slits 32a to 32j are arranged in parallel at equal intervals.

The transparent conductive film portions of the antenna conductor 30 arranged on both sides of each of the slits 32a to 32j functions as a pair of electrodes of a capacitor, and a plurality of capacitors connected in series are formed in the region of the antenna conductor 30 in which the second slit group 32 is formed.

For example, each of the slits 32a to 32j has the slit width Sw of 3 mm, and the slit length Sl of 20 mm.

A second inductor group 62 and the second slit group 32 constitute a left handed transmission line of the CRLH transmission line.

As illustrated in FIG. 3, the second inductor group 62 includes a plurality of inductors 62a to 62j electrically connected between one side surface sides of the respective plurality of slits 32a to 32j of the antenna conductor 30 and the first bezel 111 of the metal housing 10.

The plurality of inductors 62a to 62j are connected in parallel to the antenna conductor 30.

The inductance of each of the inductors 62a to 62j is 10 nH.

The plurality of slits 32a to 32j of the second slit group 32 and the plurality of inductors 62a to 62j of the second inductor group 62 are alternately aligned close to each other.

The slits 32a to 32j and the inductors 62a to 62j connected to the one side surface sides of the slits 32a to 32j are used unit cells, that is, one capacitor and one inductor are used as a unit cell, and the period length p of the unit cell including the width of the slit and the width of the inductor in the unit cell is, for example, 5 mm.

By means of, the region of the antenna conductor 30 in which the second slit group 32 including the plurality of slits 32a to 32j is formed, the second inductor group 62 that includes the plurality of inductors 62a to 62j, and the metal housing 10, there is a second CRLH transmission line 72 including: the left handed transmission line formed by the second slit group 32 and the second inductor group 62; and the right handed transmission line that is present on the slot line in the region of the antenna conductor 30 in which the second slit group 32 is formed.

The second CRLH transmission line 72 is one type of a metamaterial, and is a transmission line that indicates the property of the right handed transmission line or indicates the property of the left handed transmission line depending on a frequency.

The second CRLH transmission line 72 is present, so that it is possible to cause the second CRLH transmission line 72 on the slot line to function to operate as a leaky wave antenna.

The number of the slits 32a to 32j of the second slit group 32 and the number of the inductors 62a to 62j are 10, yet only have to be two or more instead of 10.

A planar shape of the antenna conductor 30 (hereinafter, referred to simply as a planar shape) including the region in which the first slit group 31 is formed and the region in which the second slit group 32 is formed is rectangular.

When the liquid crystal display 40 is attached inside the metal housing 10, as illustrated in FIG. 4, the antenna conductor 30 is disposed directly above the ITO film 41, and the planar shape of the antenna conductor 30 is the rectangular shape having the same size as that of a planar shape of the transparent electrode 41.

That is, the antenna conductor 30 covers the ITO film 41.

Hence, the ITO film 41 is not present directly below a magnetic current O that is a radiation source produced in the slot line formed between the end surface of the antenna conductor 30 and the edges of the bezel 110 of the metal housing 10.

As a result, capacitive coupling between the antenna conductor 30 and the ITO film 41 is suppressed, the current flowing in the ITO film 41 due to the capacitive coupling is reduced, and a decrease in gain is prevented.

Note that the planar shape of the antenna conductor 30 may not have the same size as that of the planar shape of the transparent electrode 41, and, under a condition that the gap Dm formed between the end surface of the antenna conductor 30 and the edges of the bezel 110 of the metal housing 10 enables the slot line to be present, the planar shape of the antenna conductor 30 may be larger or smaller than the planar shape of the transparent electrode 41.

In short, it is sufficient that, relative to an opening area of the opening part 10a of the metal housing 10, the planar shape of the antenna conductor 30 has a size of a planar area that enables the slot line in which the gap Dm functions as the leaky wave antenna to be present.

Next, a design idea of the antenna device according to Embodiment 1 will be described.

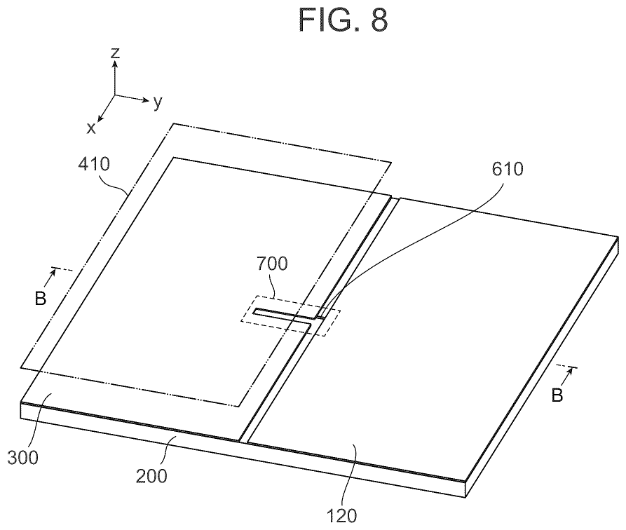

First, a slot line model using a simple CRLH transmission line based on a unit cell 700 including one capacitor connected in series and one inductor connected in parallel, the unit cell 700 being formed using a transparent conductive film 300 corresponding to the antenna conductor 30 in which one slit 310 has been formed, and an inductor 610, will be described with reference to FIGS. 8 to 10.

The transparent conductive film 300 is mounted on the surface of a glass 200 corresponding to the protective glass 20.

A metal film 120 corresponding to the metal housing 10 is mounted on the surface of the glass 200 with the gap Dm provided between one end surface of the metal film 120 and an end surface of the transparent conductive film 300.

The gap Dm forms a slot line, and the unit cell 700 is disposed at a center position in a transmission direction of the slot line. The slit 310 has an end surface opened in contact with the slot line, and has a square shape.

Transparent conductive film portions of the transparent conductive film 300 arranged on both sides of the slit 310 play a role of a pair of electrodes of the capacitor connected in series.

An ITO film 410 corresponding to the ITO film 41 has the same size as that of the transparent conductive film 300, and is disposed directly above the transparent conductive film 300.

The inductor 610 is connected between the transparent conductive film 300 and the metal film 120, and plays a role of the inductor connected in parallel.

It is assumed that the slit width Sw is 3 mm, the slit length Sl is 20 mm, an inductance of the inductor 610 is 10 nH, and the period length p of the unit cell 700 is 5 mm.

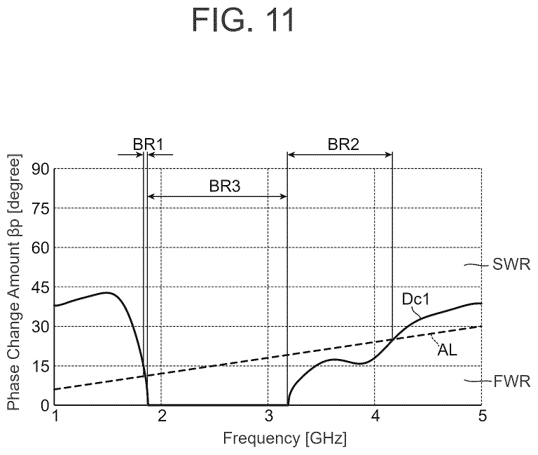

Dispersion characteristics illustrated in FIG. 11 can be obtained from the unit cell 700 configured as described above.

In FIG. 11, the horizontal axis indicates a frequency, the vertical axis indicates a phase change amount βp that is a value obtained by multiplying the period length p on a phase constant β and is obtained before and after an electromagnetic wave passes in the unit cell 700, a solid line DC1 indicates the dispersion characteristics of the unit cell 700 indicating a relationship between the frequency and the phase change amount, and a broken line AL will be referred to as AirLine.

AirLine indicates a phase speed of a light speed (ω=βc and, here, ω represents an angular frequency [rad/s], β represents a phase constant [rad/m], and c represents the light speed (≈3×10⁸ [m/s])).

A region whose phase constant is smaller than that of AirLine (AL) is a fast wave region FWR, and a region whose phase constant is larger than that of AirLine (AL) is a slow wave region SWR.

In a band in which the dispersion characteristics DC1 are located in the fast wave region FWR, the transmission line in which the unit cell 700 on the slot line is present operates as a leaky wave antenna.

In a band in which the dispersion characteristics DC1 are located in the slow wave region SWR, the transmission line in which the unit cell 700 on the slot line is present does not produce a leaky wave.

As is understood from the dispersion characteristics of the unit cell 700 illustrated in FIG. 11, a band BR1 whose frequency is around 1.8 GHz and a band BR2 of 3.2 GHz to 4.2 GHz are located in the fast wave region FWR, and a transmission line formed by the slot line operates as the leaky wave antenna.

Furthermore, a band BR3 whose phase change amount βp is 0, that is a band between the band BR1 and the band BR2 in FIG. 11 is a band gap region, and is a region in which an electromagnetic wave does not propagate in a transmission line in which the unit cell 700 on the slot line is present.

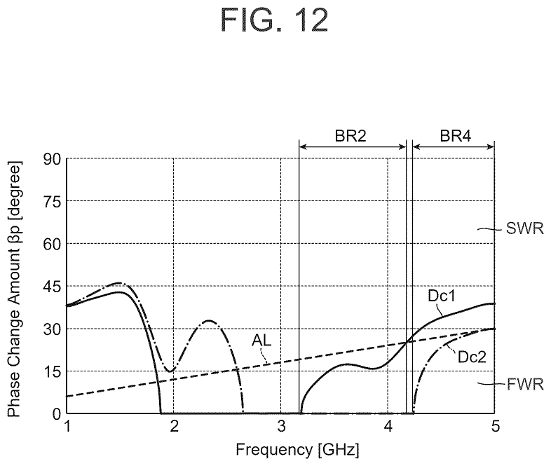

Next, a result illustrated in FIG. 12 is obtained by changing the slit length S1 from 20 mm to 16 mm in the unit cell 700 and checking the dispersion characteristics of the unit cell 700.

Note that the slit width Sw is 3 mm, the inductance of the inductor 610 is 10 nH, and the period length p of the unit cell 700 is 5 mm, which are the same as those of the unit cell 700 whose slit length S1 is 20 mm.

In FIG. 12, the solid line DC1 indicates the dispersion characteristics of the unit cell 700 whose slit length S1 is 20 mm, and a dashed dotted line DC2 indicates the dispersion characteristics of the unit cell 700 whose slit length S1 is 16 mm.

As is understood from the dispersion characteristics of the unit cell 700 illustrated in FIG. 12, a band BR4 whose frequency is 4.3 GHZ to 5 GHz is located in the fast wave region FWR, and the transmission line in which the unit cell 700 on the slot line is present operates as a leaky wave antenna.

Hence, the slit length Sl only has to be set to 20 mm for the band BR1 whose frequency range of an electromagnetic wave is around 1.8 GHz and the band BR2 of 3.2 GHz to 4.2 GHz, and the slit length Sl only has to be set to 16 mm for the band BR4 of 4.3 GHz to 5 Ghz.

Although it is described that the slit length Sl is 20 mm and 16 mm, it is possible to change a frequency range at which the transmission line operates as a leaky wave antenna by changing the length of the slit length Sl, and use the transmission line formed by the slot line as the leaky wave antenna for various frequency ranges.

That is, it is possible to obtain an antenna device that is adjusted to a frequency band of an electromagnetic wave depending on the length of the slit length Sl.

Note that, although the frequency range at which a transmission line operates as the leaky wave antenna can be changed by changing the slit length Sl, a capacitance value of the unit cell 700 can be also changed depending on the slit width Sw, so that it is possible to obtain an antenna device that is adjusted to a frequency band of an electromagnetic wave depending on the length of the slit length Sl.

Similarly, it is possible to obtain an antenna device that is adjusted to a frequency band of an electromagnetic wave depending on the inductance of the inductor 610 of the unit cell 700.

Because the one unit cell 700 produces a small leakage amount of an electromagnetic wave even when the slot line is caused to operate as a leaky wave antenna, it is better to increase a leakage amount of an electromagnetic wave that propagates on the slot line by arranging a plurality of the unit cells 700.

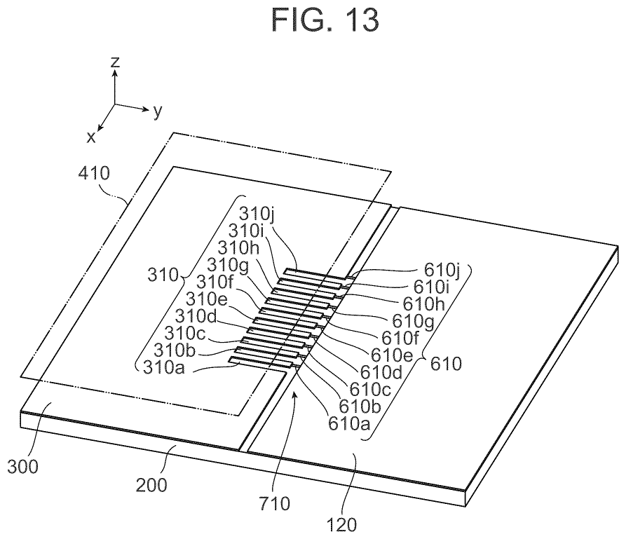

FIG. 13 illustrates a slot line model formed by a CRLH transmission line in which 10 unit cells have been arranged.

The slot line model illustrated in FIG. 13 is a slot line model formed by the CRLH transmission line in which the 10 unit cells illustrated in FIGS. 8 to 10 have been arranged in parallel along the slot line.

The transparent conductive film 300 includes the slit group 310 including 10 slits 310a to 310j each of whose end surface is opened in contact with the slot line.

10 inductors 610a to 610j electrically connected between one side surface sides of the 10 respective slits 310a to 310j of the transparent conductive film 300 and the metal film 120 constitute a first inductor group 61.

The 10 slits 310a to 310j of the first slit group 310 and the 10 inductors 610a to 610j are alternately aligned close to each other.

Hence, by means of the region of the transparent conductive film 300 in which the slit group 310 is formed, and the 10 inductors 610a to 610j, there is the CRLH transmission line 710 that includes the 10 unit cells 700.

Similarly to the dispersion characteristics of the one unit cell 700 (see FIG. 11), in the CRLH transmission line 710 that includes the 10 unit cells 700 configured as described above, too, the band BR1 whose frequency is around 1.8 GHz and the band BR2 of 3.2 GHz to 4.2 GHz are located in the fast wave region FWR, a transmission line formed by the slot line operates as a leaky wave antenna, and a band between the band BR1 and the band BR2 is a band gap region.

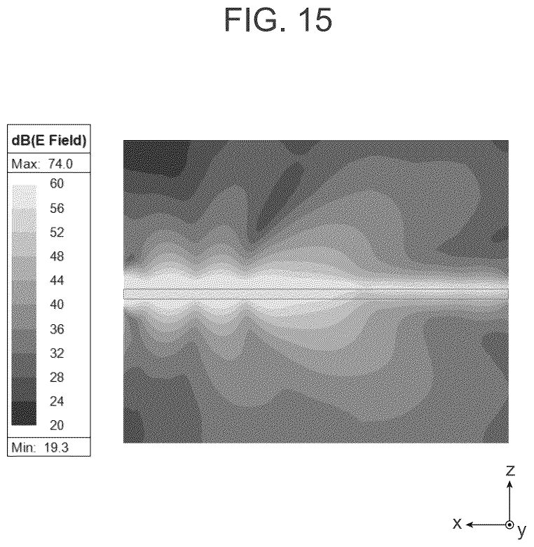

FIG. 15 illustrates in the CRLH transmission line 710 including the 10 unit cells 700 configured as described above, an electrical field distribution at a time when an electromagnetic wave of 4 GHz at which the transmission line including the 10 unit cells 700 on the slot line operates as a leaky wave antenna is caused to propagate from a +direction to a −direction of the x axis illustrated in FIG. 13.

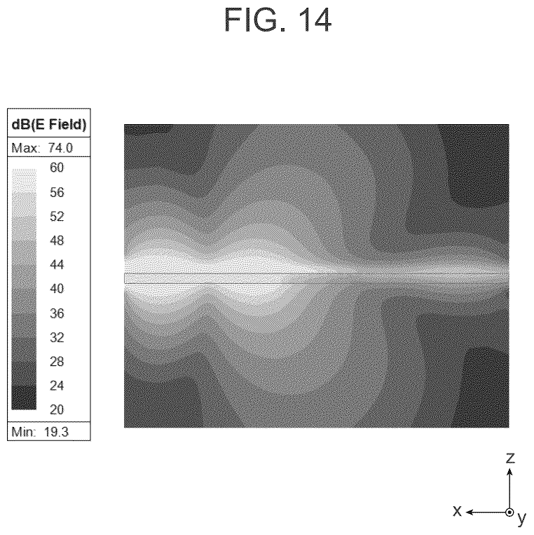

Furthermore, FIG. 14 illustrates an electrical field distribution at a time when an electromagnetic wave of 2 GHz that is a band gap region is caused to propagate.

As is understood from FIG. 14, it is possible to confirm from the CRLH transmission line 710 including the 10 unit cells 700 that the electromagnetic wave leaks to space.

Furthermore, as is understood from FIG. 15, it is possible to confirm from the CRLH transmission line 710 including the 10 unit cells 700 that the electromagnetic wave does not leak and the electromagnetic wave does not propagate beyond the CRLH transmission line 710.

Next, a test result of a gain with respect to a frequency in the antenna device according to Embodiment 1 will be described.

In the antenna device according to Embodiment 1, each of the first CRLH transmission line 71 and the second CRLH transmission line 72 is designed in the same way as that of the CRLH transmission line 710 including the 10 unit cells 700 illustrated in FIG. 13.

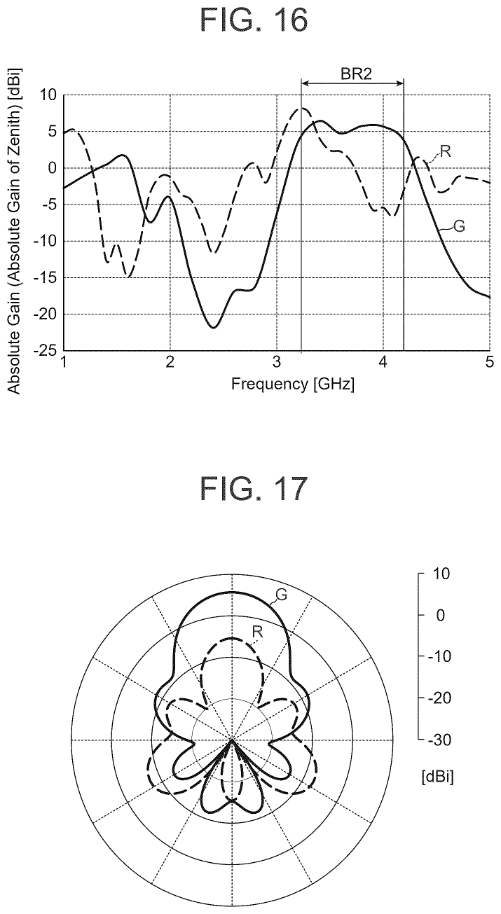

An absolute gain that is a test result of the antenna device according to Embodiment 1 and is obtained in a zenith direction (+z direction) with respect to the frequency is indicated by a solid line G in FIG. 16, and an absolute gain radiation pattern of a vertical plane (z-y plane) is indicated by a solid line G in FIG. 17.

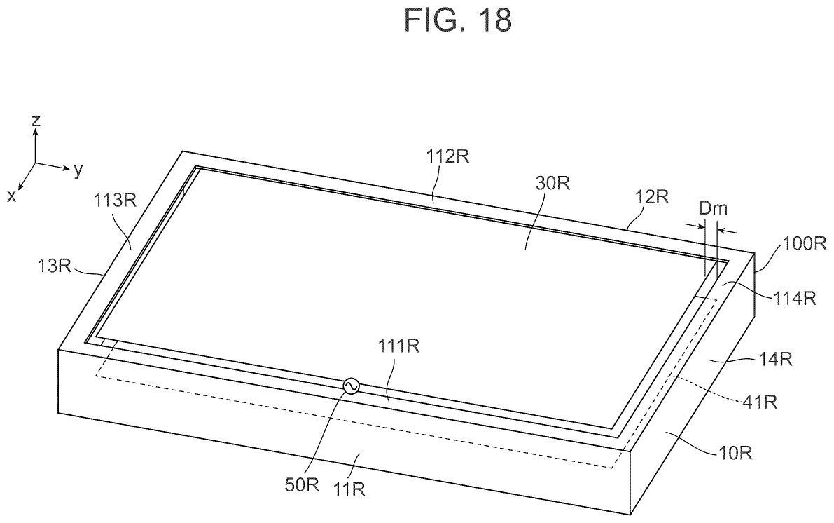

Note that, for reference, an absolute gain that is a test result according to a comparative example illustrated in FIGS. 18 to 20 and is obtained in the zenith direction (+z direction) with respect to the frequency is indicated by a broken line R in FIG. 16, and an absolute gain radiation pattern of the vertical plane (z-y plane) is indicated by the broken line R in FIG. 17.

An antenna device according to the comparative example is antenna device in which an antenna conductor 30R has the shape covering an ITO film 41R, and uses the magnetic current O produced in the gap Dm between a bezel 110R (111R to 114R) of a metal housing 10R and the antenna conductor 30R.

That is, an antenna device according to a comparative example employs the following configuration.

The metal housing 10R is a cuboid that includes the opening part 10a on one surface and includes the first sidewall 11 to the fourth sidewall 14 and the bottom plate 15, and includes the bezel 110R (111R to 114R) that constitutes an outer frame.

The antenna conductor 30R is mounted on the back surface of a protective glass 20R, and is a rectangular transparent conductive film.

The antenna conductor 30R is disposed directly above the rectangular ITO film 41R provided to a liquid crystal screen of a liquid crystal display.

The antenna conductor 30R and the ITO film 41R have the same shape and the same size.

The antenna device according to the comparative example has the same shape as that of the antenna device according to Embodiment 1 except that the antenna device according to the comparative example does not include the first CRLH transmission line 71 and the second CRLH transmission line 72 according to Embodiment 1, that is, the antenna conductor 30R does not include the first slit group 31, the second slit group 32, the first inductor group 61, and the second inductor group 62.

As is understood from the solid line G in FIG. 16, the antenna device according to Embodiment 1 has a high absolute gain in the zenith direction in the band BR2 of 3.2 GHz to 4.2 GHz compared to the antenna device according to the comparative example (broken line R). A reason why the absolute gain in the zenith direction is high is that the first CRLH transmission line 71 and the second CRLH transmission line 72 operate as the leaky wave antennas, and the gain increases.

Furthermore, as is understood from the solid line G in FIG. 17, the antenna device according to Embodiment 1 has an increased absolute gain in a front direction at a frequency of 4 GHz compared to the antenna device according to the comparative example (broken line R).

As described above, the antenna device according to Embodiment 1 has a high absolute gain in the zenith direction in the wide frequency band BR2 of 3.2 GHz to 4.2 GHz without changing the size of the metal housing, and is applicable to wide usage.

Note that, in a case where the slit length Sl is set to 16 mm, the antenna device according to Embodiment 1 can obtain a high absolute gain in the zenith direction in the band BR4 of 4.3 GHZ to 5 GHz at which the leaky wave antenna described with reference to FIG. 12 operates.

As described above, in the antenna device according to Embodiment 1, the composite right handed/left handed transmission line is formed on at least part of the slot line in the antenna conductor 30 that forms the gap Dm that is the slot line between the antenna conductor 30 and the edges surrounding the opening part 10a of the metal housing 10, and the composite right handed/left handed transmission line on the slot line is caused to function as the leaky wave antenna, so that it is possible to obtain a high gain with respect to a wide frequency band without depending on the size of the metal housing 10, and usage expands.

Furthermore, the antenna device according to Embodiment 1 is provided with the plurality of slits 31a to 31j and 32a to 32j whose end surfaces are opened in contact with the gap Dm and that are arranged in parallel in the antenna conductor 30 that forms the gap Dm that is the slot line between the antenna conductor 30 and the edges surrounding the opening part 10a of the metal housing 10, and includes the plurality of inductors 61a to 61j electrically connected between one side surface sides of the respective plurality of slits 31a to 31j and 32a to 32j of the antenna conductor 30 and the metal housing 10, so that it is possible to obtain a high gain with respect to a wide frequency band without depending on the size of the metal housing 10, moreover, it is possible to change a frequency band with a high gain by changing at least one of the slit length Sl, the slit width Sw of each of the slits 31a to 31j and 32a to 32j, or the inductance of the inductors 61a to 61j without depending on the size of the metal housing 10, and the usage further expands.

### Embodiment 2

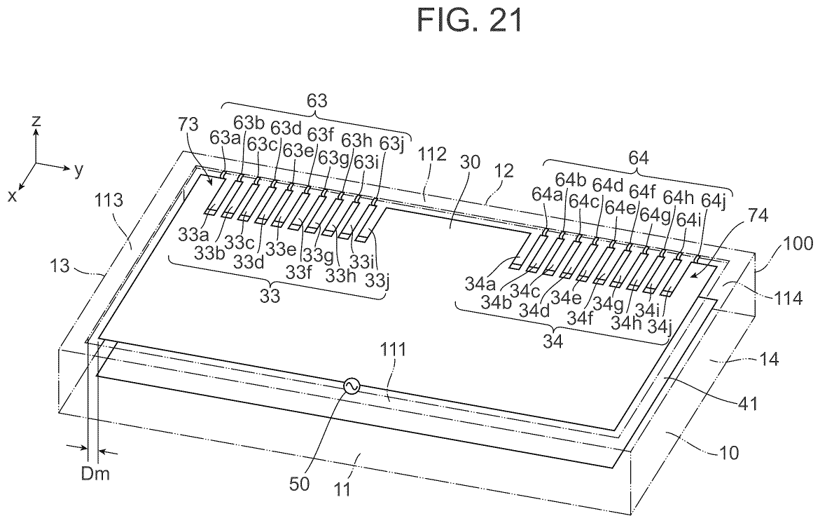

An antenna device according to Embodiment 2 will be described with reference to FIG. 21.

In the antenna device according to Embodiment 1, the first CRLH transmission line 71 and the second CRLH transmission line 72 are arranged on the same side of the one side of the opening part 10a as the side of the one side of the opening part 10a of the metal housing 10 in which the power feeding point 50 is disposed, that is, on the side of the first sidewall 11 of the metal housing 10.

By contrast with this, in the antenna device according to Embodiment 2, a third CRLH transmission line 73 and a fourth CRLH transmission line 74 are arranged on the side of the one side of the opening part 10a opposing to the side of the one side of the opening part 10a of the metal housing 10 in which the power feeding point 50 is disposed, that is, on the side of the second sidewall 12 of the metal housing 10.

Other points of the antenna device according to Embodiment 2 are the same as those of the antenna device according to Embodiment 1.

Note that, in FIG. 21, the same reference numerals assigned in FIGS. 1 to 4 indicate identical or corresponding parts.

Hereinafter, differences from the antenna device according to Embodiment 1 will be mainly described.

The third CRLH transmission line 73 is disposed on the side of a third bezel 113 of the metal housing 10.

The third CRLH transmission line 73 includes the region of the antenna conductor 30 in which a third slit group 33 is formed, and a plurality of inductors 63a to 63j.

The third slit group 33 includes a plurality of slits 33a to 33j each of whose end surface is opened in contact with the slot line on the side of a second bezel 112 of the metal housing 10, and the plurality of slits 33a to 33j are arranged in parallel at equal intervals.

The number of the plurality of slits 33a to 33j is, for example, 10, and the slit width Sw and the slit length Sl of each of the slits 33a to 33j are, for example, 3 mm and 20 mm, respectively.

A third inductor group 63 includes the plurality of inductors 63a to 63j electrically connected between one side surface sides of the respective plurality of slits 33a to 33j of the antenna conductor 30 and the second bezel 112 of the metal housing 10.

The plurality of inductors 63a to 63j are connected in parallel to the antenna conductor 30.

The number of the plurality of inductors 63a to 63j is, for example, 10, and the inductance of each of the inductors 63a to 63j is 10 nH.

The fourth CRLH transmission line 74 is disposed on the side of the fourth bezel 114 of the metal housing 10.

The third CRLH transmission line 73 and the fourth CRLH transmission line 74 are arranged symmetrically with respect to a center point of a longitudinal direction, that is, a y axis direction of the second bezel 112 of the metal housing 10.

The fourth CRLH transmission line 74 includes the region of the antenna conductor 30 in which a fourth slit group 34 is formed, and a plurality of inductors 64a to 64j.

The fourth slit group 34 includes a plurality of slits 34a to 34j each of whose end surface is opened in contact with the slot line on the side of the second bezel 112 of the metal housing 10, and the plurality of slits 34a to 34j are arranged in parallel at equal intervals.

The number of the plurality of slits 34a to 34j is, for example, 10, and the slit width Sw and the slit length Sl of each of the slits 34a to 34j are, for example, 3 mm and 20 mm, respectively.

A fourth inductor group 64 includes the plurality of inductors 64a to 64j electrically connected between one side surface sides of the respective plurality of slits 34a to 34j of the antenna conductor 30 and the second bezel 112 of the metal housing 10.

The plurality of inductors 64a to 64j are connected in parallel to the antenna conductor 30.

The number of the plurality of inductors 64a to 64j is, for example, 10, and the inductance of each of the inductors 64a to 64j is 10 nH.

The antenna device according to Embodiment 2 has the same effect as that of the antenna device according to Embodiment 1.

### Embodiment 3

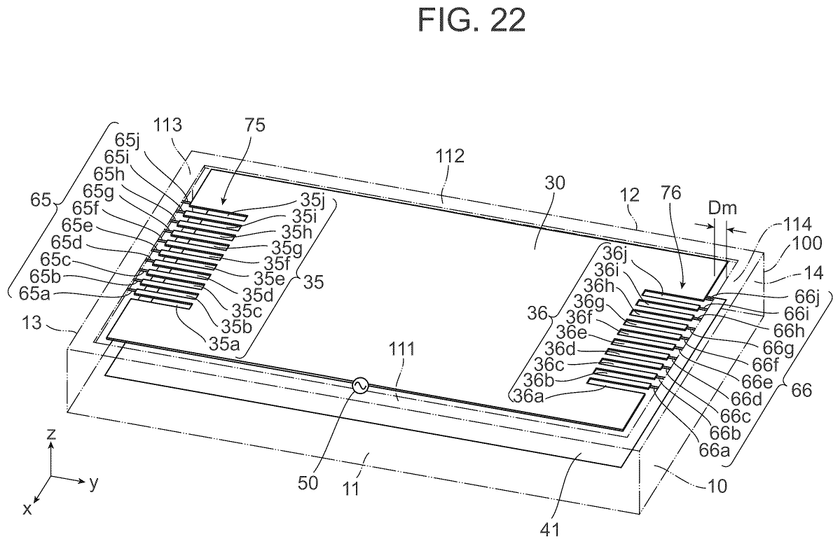

An antenna device according to Embodiment 3 will be described with reference to FIG. 22.

In the antenna device according to Embodiment 1, the first CRLH transmission line 71 and the second CRLH transmission line 72 are arranged on the side of the same one side of the opening part 10a as the side of the one side of the opening part 10a of the metal housing 10 in which the power feeding point 50 is disposed, that is, on the side of the first sidewall 11 of the metal housing 10.

By contrast with this, in the antenna device according to Embodiment 3, a fifth CRLH transmission line 75 and a sixth CRLH transmission line 76 are arranged on the sides of the respective sides of the opening part 10a perpendicular to the side of the one side of the opening part 10a of the metal housing 10 in which the power feeding point 50 is disposed, that is, on the side of the third sidewall 13 and the side of the fourth sidewall 14 of the metal housing 10, respectively.

Other points of the antenna device according to Embodiment 3 are the same as those of the antenna device according to Embodiment 1.

Note that, in FIG. 22, the same reference numerals assigned in FIGS. 1 to 4 indicate identical or corresponding parts.

Hereinafter, differences from the antenna device according to Embodiment 1 will be mainly described.

The fifth CRLH transmission line 75 is disposed at the center in the longitudinal direction of the third bezel 113 of the metal housing 10.

The fifth CRLH transmission line 75 includes the region of the antenna conductor 30 in which a fifth slit group 35 is formed, and a plurality of inductors 65a to 65j.

The fifth slit group 35 includes a plurality of slits 35a to 35j each of whose end surface is opened in contact with the slot line on the side of the third bezel 113 of the metal housing 10, and the plurality of slits 35a to 35j are arranged in parallel at equal intervals.

The number of the plurality of slits 35a to 35j is, for example, 10, and the slit width Sw and the slit length Sl of each of the slits 35a to 35j are, for example, 3 mm and 20 mm, respectively.

A fifth inductor group 65 includes the plurality of inductors 65a to 65j electrically connected between one side surface sides of the respective plurality of slits 35a to 35j of the antenna conductor 30 and the third bezel 113 of the metal housing 10.

The plurality of inductors 65a to 65j are connected in parallel to the antenna conductor 30.

The number of the plurality of inductors 65a to 65j is, for example, 10, and the inductance of each of the inductors 65a to 65j is 10 nH.

The sixth CRLH transmission line 76 is disposed at the center in the longitudinal direction on the side of the fourth bezel 114 of the metal housing 10.

The sixth CRLH transmission line 76 includes the region of the antenna conductor 30 in which a sixth slit group 36 is formed, and a plurality of inductors 66a to 66j.

The sixth slit group 36 includes a plurality of slits 36a to 36j each of whose end surface is opened in contact with the slot line on the side of the fourth bezel 114 of the metal housing 10, and the plurality of slits 36a to 36j are arranged in parallel at equal intervals.

The number of the plurality of slits 36a to 36j is, for example, 10, and the slit width Sw and the slit length Sl of each of the slits 36a to 36j are, for example, 3 mm and 20 mm, respectively.

A sixth inductor group 66 includes a plurality of inductors 66a to 66j electrically connected between one side surface sides of the respective plurality of slits 36a to 36j of the antenna conductor 30 and the fourth bezel 114 of the metal housing 10.

The plurality of inductors 66a to 66j are connected in parallel to the antenna conductor 30.

The number of the plurality of inductors 66a to 66j is, for example, 10, and the inductance of each of the inductors 66a to 66j is 10 nH.

The antenna device according to Embodiment 3 has the same effect as that of the antenna device according to Embodiment 1.

### Embodiment 4

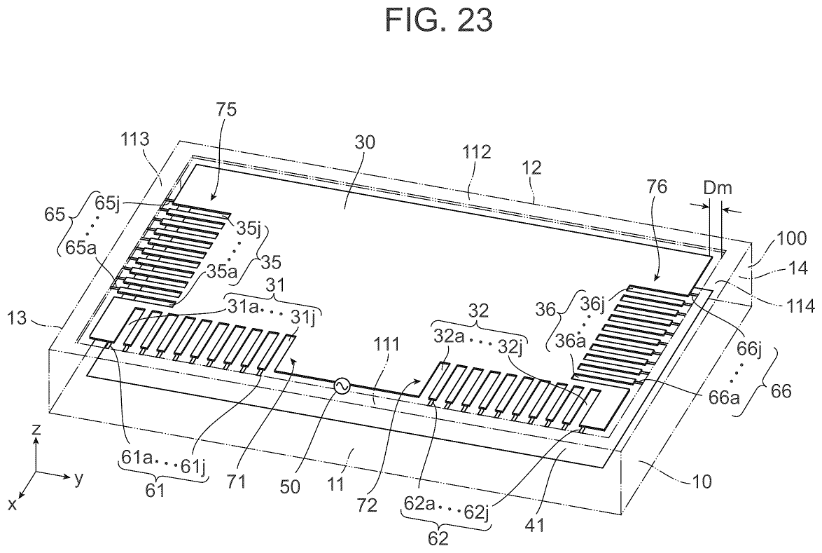

An antenna device according to Embodiment 4 will be described with reference to FIG. 23.

In the antenna device according to Embodiment 1, the first CRLH transmission line 71 and the second CRLH transmission line 72 are arranged on the side of the same one side of the opening part 10a as the side of the one side of the opening part 10a of the metal housing 10 in which the power feeding point 50 is disposed, that is, on the side of the first sidewall 11 of the metal housing 10.

By contrast with this, in the antenna device according to Embodiment 4, in addition to the first CRLH transmission line 71 and the second CRLH transmission line 72, the fifth CRLH transmission line 75 and the sixth CRLH transmission line 76 are arranged on the sides of the respective sides of the opening part 10a perpendicular to the side of the one side of the opening part 10a of the metal housing 10 in which the power feeding point 50 is disposed, that is, on the side of the third sidewall 13 and the side of the fourth sidewall 14 of the metal housing 10, respectively.

That is, the antenna device according to Embodiment 4 includes the first CRLH transmission line 71 and the second CRLH transmission line 72, and the fifth CRLH transmission line 75 and the sixth CRLH transmission line 76.

Next, other points of the antenna device according to Embodiment 4 are the same as those of the antenna device according to Embodiment 1.

Note that, in FIG. 23, the same reference numerals assigned in FIGS. 1 to 4 indicate identical or corresponding parts.

The fifth CRLH transmission line 75 and the sixth CRLH transmission line 76 are the same as the fifth CRLH transmission line 75 and the sixth CRLH transmission line 76 in the antenna device according to Embodiment 3.

The antenna device according to Embodiment 4 has the same effect as that of the antenna device according to Embodiment 1.

### Embodiment 5

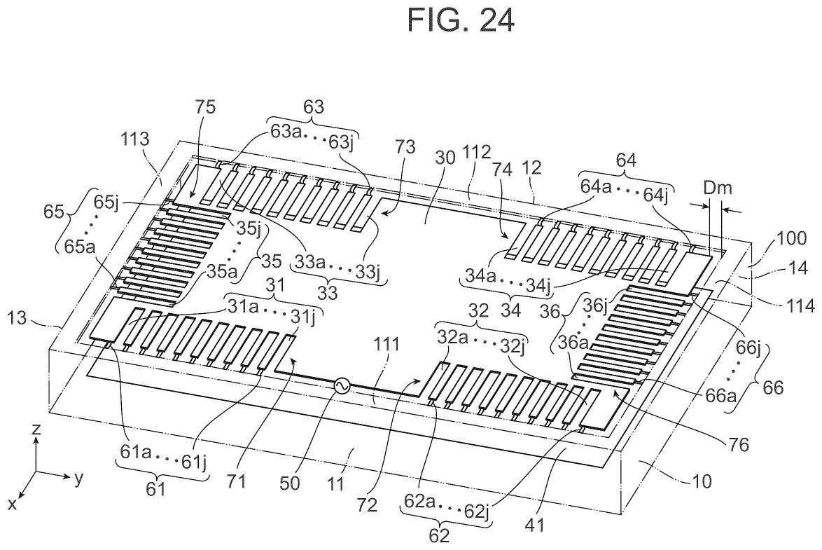

An antenna device according to Embodiment 5 will be described with reference to FIG. 24.

In the antenna device according to Embodiment 1, the first CRLH transmission line 71 and the second CRLH transmission line 72 are arranged on the side of the same one side of the opening part 10a as the side of the one side of the opening part 10a of the metal housing 10 in which the power feeding point 50 is disposed, that is, on the side of the first sidewall 11 of the metal housing 10.

By contrast with this, in the antenna device according to Embodiment 5, in addition to the first CRLH transmission line 71 and the second CRLH transmission line 72, the third CRLH transmission line 73 and the fourth CRLH transmission line 74 are arranged on the side of the one side of the opening part 10a opposing to the side of the one side of the opening part 10a of the metal housing 10 in which the power feeding point 50 is disposed, that is, on the side of the second sidewall 12 of the metal housing 10, and the fifth CRLH transmission line 75 and the sixth CRLH transmission line 76 are arranged on the sides of the respective sides of the opening part 10a perpendicular to the side of the one side of the opening part 10a of the metal housing 10 in which the power feeding point 50 is disposed, that is, on the side of the third sidewall 13 and the side of the fourth sidewall 14 of the metal housing 10, respectively.

That is, the antenna device according to Embodiment 5 includes the first CRLH transmission line 71 and the second CRLH transmission line 72, the third CRLH transmission line 73 and the fourth CRLH transmission line 74, and the fifth CRLH transmission line 75 and the sixth CRLH transmission line 76.

The antenna device according to Embodiment 5 includes the CRLH transmission lines 71 to 74 arranged on all four sides of the opening part 10a of the metal housing 10.

Other points of the antenna device according to Embodiment 5 are the same as those of the antenna device according to Embodiment 1.

Note that, in FIG. 24, the same reference numerals assigned in FIGS. 1 to 4 indicate identical or corresponding parts.

The third CRLH transmission line 73 and the fourth CRLH transmission line 74 are the same as the third CRLH transmission line 73 and the fourth CRLH transmission line 74 in the antenna device according to Embodiment 2.

The fifth CRLH transmission line 75 and the sixth CRLH transmission line 76 are the same as the fifth CRLH transmission line 75 and the sixth CRLH transmission line 76 in the antenna device according to Embodiment 3.

The antenna device according to Embodiment 5 has the same effect as that of the antenna device according to Embodiment 1.

### Embodiment 6

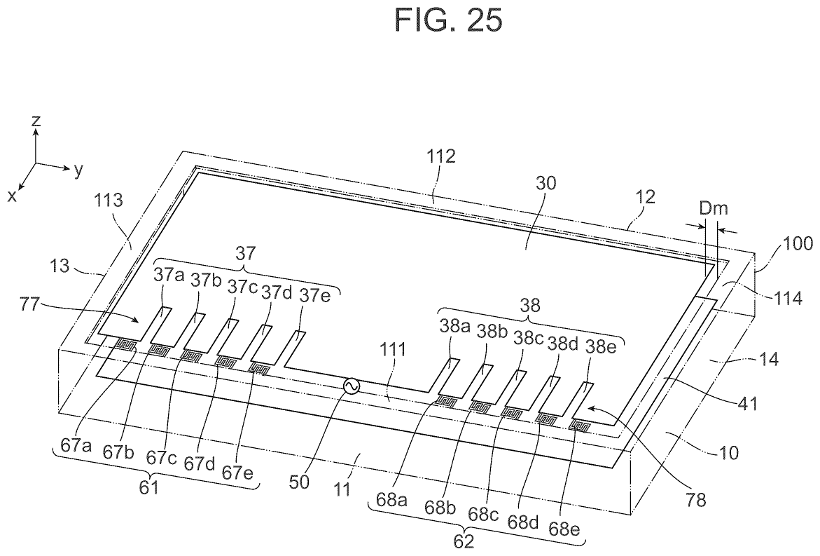

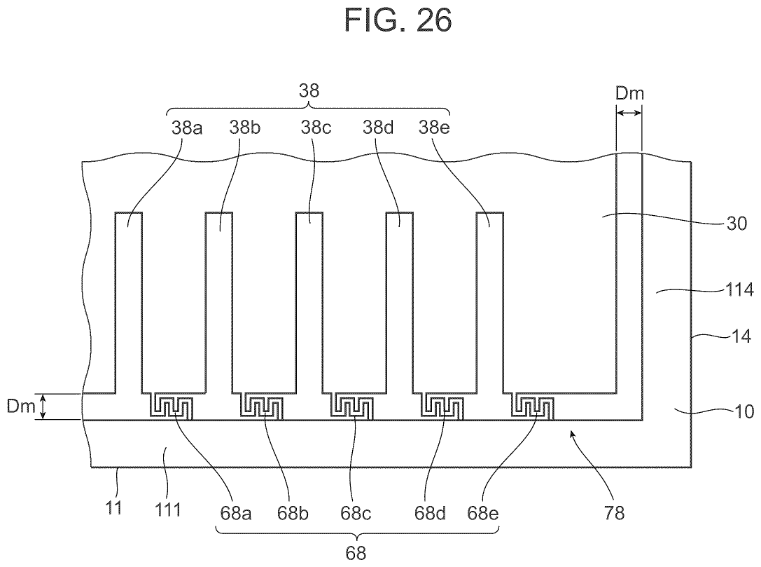

An antenna device according to Embodiment 6 will be described with reference to FIGS. 25 and 26.

The antenna device according to Embodiment 6 differs from the antenna device according to Embodiment 1 in using meander elements as inductors, and other points are the same as those of the antenna device according to Embodiment 1.

Note that, in FIGS. 25 and 26, the same reference numerals assigned in FIGS. 1 to 4 indicate identical or corresponding parts.

Hereinafter, differences from the antenna device according to Embodiment 1 will be mainly described.

In the antenna device according to Embodiment 6, a seventh CRLH transmission line 77 and an eighth CRLH transmission line 78 are arranged on the same side of the one side of the opening part 10a as the side of the one side of the opening part 10a of the metal housing 10 in which the power feeding point 50 is disposed, that is, on the side of the first sidewall 11 of the metal housing 10.

The seventh CRLH transmission line 77 is disposed on the side of the third bezel 113 of the metal housing 10.

The seventh CRLH transmission line 77 includes the region of the antenna conductor 30 in which a seventh slit group 37 is formed, and a plurality of inductors 67a to 67e.

The seventh slit group 37 includes a plurality of slits 37a to 37e each of whose end surface is opened in contact with the slot line on the side of the first bezel 111 of the metal housing 10, and the plurality of slits 37a to 37e are arranged in parallel at equal intervals.

The number of the plurality of slits 37a to 37e is, for example, five.

A seventh inductor group 67 includes the plurality of inductors 67a to 67e electrically connected between one side surface sides of the respective plurality of slits 37a to 37e of the antenna conductor 30 and the first bezel 111 of the metal housing 10.

The plurality of inductors 67a to 67e are connected in parallel to the antenna conductor 30.

Each of the inductors 67a to 67e is a meander element.

The number of the plurality of inductors 67a to 67e is, for example, five.

The eighth CRLH transmission line 78 is disposed on the side of the fourth bezel 114 of the metal housing 10.

The seventh CRLH transmission line 77 and the eighth CRLH transmission line 78 are arranged symmetrically with respect to the center point of the longitudinal direction, that is, the y axis direction of the first bezel 111 of the metal housing 10.

The eighth CRLH transmission line 78 includes the region of the antenna conductor 30 in which an eighth slit group 38 is formed, and a plurality of inductors 68a to 68e.

The eighth slit group 38 includes a plurality of slits 38a to 38e each of whose end surface is opened in contact with the slot line on the side of the first bezel 111 of the metal housing 10, and the plurality of slits 38a to 38e are arranged in parallel at equal intervals.

The number of the plurality of slits 38a to 38e is, for example, five.

An eighth inductor group 68 includes the plurality of inductors 68a to 68e electrically connected between one side surface sides of the respective plurality of slits 38a to 38e of the antenna conductor 30 and the first bezel 111 of the metal housing 10.

The plurality of inductors 68a to 68e are connected in parallel to the antenna conductor 30.

Each of the inductors 68a to 68e is a meander element.

The number of the plurality of inductors 68a to 68e is, for example, five.

The antenna device according to Embodiment 6 has the same effect as that of the antenna device according to Embodiment 1, and, in addition, uses the meander elements as the inductors and consequently can reduce the number of elements of the inductors.

Note that the embodiments can be freely combined, any components in the embodiments can be modified, or any components in the embodiments can be omitted.

### INDUSTRIAL APPLICABILITY

The antenna device according to the present disclosure is applied to an antenna device that uses an antenna conductor that allows visible light to transmit therethrough, and is applied to a liquid crystal display device in which a liquid crystal display is disposed inside a metal housing.

### REFERENCE SIGNS LIST

10: metal housing, 10a: opening part, 20: protective glass, 30: antenna conductor, 31 to 37: slit group, 31a to 31j, 32a to 32j, 33a to 33j, 34a to 34j, 35a to 35j, 36a to 36j, 37a to 37e, 38a to 38e: slit, 40: liquid crystal display, 41: transparent electrode (ITO film), 50: power feeding point, 61 to 68: inductor group, 61a to 61j, 62a to 62j, 63a to 63j, 64a to 64j, 65a to 65j, 66a to 66j, 67a to 67e, 68a to 68e: inductor, 71 to 78: CRLH transmission line

1. An antenna device comprising:
a metal housing which includes an opening part on one surface, and in which a liquid crystal display including a transparent conductive film facing the opening part is disposed;
an antenna conductor that includes an end surface forming a gap being a slot line between the end surface and an edge surrounding the opening part of the metal housing, constitutes a composite right handed/left handed transmission line on at least part of the slot line, causes the composite right handed/left handed transmission line on the slot line to function as a leaky wave antenna, and allows visible light to transmit through the antenna conductor; and
a power feeding point disposed in the gap, wherein
the antenna conductor includes a slit group including a plurality of slits which have end surfaces opened in contact with the slot line, and are arranged in parallel,
the plurality of slits, and a plurality of inductors electrically connected between one side surface sides of the respective plurality of slits and the metal housing constitute a left handed transmission line in the composite right handed/left handed transmission line, and
a right handed transmission line of the composite right handed/left handed transmission line is present in the slot line in a region of the antenna conductor in which the slit group is formed.

2. The antenna device according to claim 1, wherein the power feeding point is disposed at a center of one side of the opening part of the metal housing.

3. The antenna device according to claim 1, wherein the metal housing includes at the edge a bezel having a width and surrounding the opening part.

4. The antenna device according to claim 1, wherein each of the plurality of inductors is an element of a meander shape.

5. The antenna device according to claim 1, wherein the opening part of the metal housing has a rectangular shape, and the plurality of slits and the plurality of inductors are arranged on a same side of the opening part as one side of the opening part of the metal housing in which the power feeding point is disposed.

6. The antenna device according to claim 5, wherein the plurality of slits and the plurality of inductors are divided into two groups, and the divided groups are arranged symmetrically with respect to the power feeding point.

7. The antenna device according to claim 1, wherein the opening part of the metal housing has a rectangular shape, and the plurality of slits and the plurality of inductors are arranged on a side of the opening part opposing to one side of the opening part of the metal housing in which the power feeding point is disposed.

8. The antenna device according to claim 1, wherein the opening part of the metal housing has a rectangular shape, and the plurality of slits and the plurality of inductors are arranged on a side of the opening part perpendicular to one side of the opening part of the metal housing in which the power feeding point is disposed.

9. An antenna device comprising:
a metal housing which includes an opening part on one surface, and in which a liquid crystal display including a transparent conductive film facing the opening part is disposed;
an antenna conductor of which an end surface is disposed in such a way as to have a gap between the end surface and an edge surrounding the opening part of the metal housing, and which includes a plurality of slits having end surfaces in contact with the gap and arranged in parallel, and allows visible light to transmit through the antenna conductor;
a plurality of inductors electrically connected between one side surface sides of the respective plurality of slits of the antenna conductor and the metal housing; and
a power feeding point disposed in the gap.
